(19) United States
(12) Patent Application Publication
(10) Pub. No.: US 2022/0141545 A1
(43) Pub. Date: May 5, 2022

(54) NETWORK STREAM QUALITY MANAGEMENT

(71) Applicant: Cisco Technology, Inc., San Jose, CA (US)

(72) Inventors: Rishi Chhibber, Dublin, CA (US); Roshan Lal, San Jose, CA (US); Francesco Meo, San Jose, CA (US)

(21) Appl. No.: 17/090,191

(22) Filed: Nov. 5, 2020

(51) Int. Cl. H04N 21/647; H04N 21/2343; H04N 21/24

(52) U.S. Cl. CPC H04N 21/64738; H04N 21/64769; H04N 21/2402; H04N 21/234363

(57) ABSTRACT

A network element seamlessly provides a flow of adjustable quality to a receiver endpoint. The network element obtains from the receiver endpoint a request for a media stream. The network element subscribes to multiple flows of the media stream, with each flow corresponding to a different quality level of the media stream. The network element monitors the network performance of each of the flows and selects a first flow based on the network performance of each of the flows. The network element provides the first flow to the receiver endpoint and continues to monitor the network performance of the flows.

### TECHNICAL FIELD

The present disclosure relates to management of media streams, particularly in response to network delays.

### BACKGROUND

Media streams, such as online video streams, may be produced at varying levels of quality (e.g., resolution) to accommodate the varying capabilities of networks and end user devices. Typically, once the end user detects issues (e.g., buffering, stuttering) in a flow of a media stream of a particular quality, the end user may request a lower quality flow of the media stream. Adaptive Bitrate Encoding allows a media stream to be encoded in different flows at different quality levels to account for different bandwidth capabilities of networks and end users. Stream switching for redundancy has also been implemented, e.g., using Multicast-Only Fast ReRoute (MoFFR), redundant fabrics, or different Virtual Routing and Forwarding (VRF) values. Other examples of stream switching for redundancy may be used by endpoints that adhere to Society of Motion Picture and Television Engineers (SMPTE) 2022 standards.

### BRIEF DESCRIPTION OF THE DRAWINGS

FIG. 1 is a simplified block diagram of a media streaming system, according to an example embodiment.

FIG. 2A is a simplified block diagram illustrating a receiver requesting a media stream, according to an example embodiment.

FIG. 2B is a simplified block diagram illustrating flows providing a media stream to a receiver, according to an example embodiment.

FIG. 2C is a simplified block diagram illustrating flows providing a media stream to a receiver when one of the flows is degraded, according to an example embodiment.

FIG. 3 is a message flow diagram illustrating messages and flows providing a receiver endpoint with a media stream using flows of varying quality, according to an example embodiment.

FIG. 4 is a flowchart illustrating operations performed at a network element to provide a receiver endpoint with the optimal flow of a media stream, according to an example embodiment.

FIG. 5 is a flowchart illustrating operations performed at a network element to provide a receiver endpoint with a media stream, according to an example embodiment.

FIG. 6 illustrates a simplified block diagram of a device that may be configured to perform the methods presented herein, according to an example embodiment.

### DESCRIPTION OF EXAMPLE EMBODIMENTS

### Overview

A computer implemented method enables a network element to provide a flow to a receiver endpoint. The method includes obtaining from the receiver endpoint a request for a media stream. The method also includes subscribing to a plurality of flows of the media stream. Each flow of the plurality of flows corresponds to a quality level of the media stream. The method further includes monitoring a network performance of each of the plurality of flows. The method also includes selecting a first flow among the plurality of flows based on the network performance of each of the plurality of flows, and providing the first flow to the receiver endpoint.

### Example Embodiments

Online media streams are sensitive to network delays, which may cause a user to receive unacceptable performance. For instance, if a user requests a 4K video stream, network capacity issues may prevent the network from honoring the request, leading the video stream to frequently halt and buffer. Some services may automatically degrade the quality of the media stream in response to delivery issues. Other services may continue to attempt to buffer the media stream to compensate for the network issues. Typical solutions require end-to-end device communication over the network between the receiver endpoint and the source of the media stream. This places the responsibility for detecting flow drops and switching flows on the endpoint devices.

In one example, a source may be capable of providing flows at any given quality (e.g., frame rate, resolution, etc.), and a receiver may similarly be capable of receiving and reproducing any given quality of flow of the media stream. Initially, the receiver may request a stream, which the source provides at the highest quality (e.g., 4K resolution at 120 Hz frame rate). The receiver may find that the connection was established, but at some point the receiver fails to receive the flow due to congestion in the network. The receiver may transition to a lower quality flow (e.g., 1080p resolution) of the stream, which the source provides. However, the receiver may still see unacceptable buffering from the lower quality flow and transition to an even lower quality flow (e.g., 720p resolution) until the receiver is able to receive a stable stream without buffering and/or drops.

The techniques presented herein remove the responsibility for maintaining an acceptable stream from the receiver endpoint and places the responsibility for finding the optimal flow quality of the stream on the network (e.g., the last hop network element).

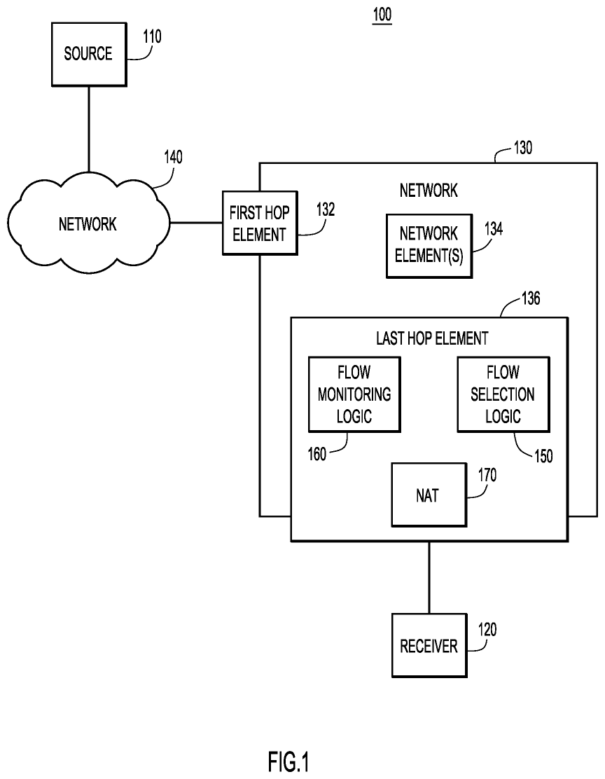

Referring now to FIG. 1, a media streaming system 100 that is configured to send media streams from a source 110 to a receiver 120 is shown. The receiver 120 is connected to a network 130, which connects to the source via a network 140. The network 130 includes a first hop network element 132 (e.g., gateway, router, switch, etc.), one or more internal network elements 134 and a last hop network element 136. In one example, the network elements 132, 134, and 136 may be configured in a spine-leaf topology. Alternatively, the network 130 may be configured in a different topology (e.g., ring, mesh, bus, star, tree, etc.). The source 110 is connected to the network 140, which connects to the first hop network element 132 of the network 130. The receiver connects to the last hop network element 136 of the network 130.

The last hop network element 136 includes flow selection logic 150, flow monitoring logic 160, and a Network Address Translation (NAT) service 170. The flow selection logic 150 enables the last hop network element 136 to select between flows of different quality for a media stream requested by the receiver 120. The flow monitoring logic 160 enables the last hop network element 136 to detect the network performance (e.g., packet drops, latency, etc.) of the different flows of a media stream. The NAT service 170 enables the last hop network element 136 to quickly and seamlessly switch the flow that is provided to the receiver 120.

In one example, the last hop network element 136 receives a request from the receiver 120 for a media stream by providing a source identifier and a group identifier (e.g., source 1 and group 10, or S1G10). The source 110 may provide multiple versions of the stream at different qualities using different group identifiers (e.g., S1G1, S1G2, S1G3, etc.). The last hop network element 136 subscribes to multiple flows of the media stream provided from the source 110. The last hop network element 136 monitors each flow to determine respective network performances, and selects one of the flows to provide to the receiver 120. In one example, the last hop network element 136 may also monitor ingress and egress bandwidth available on the network 130 to determine which flow to select to provide to the receiver 120. If the network 130 is low on available bandwidth, the last hop network element 136 may initially provide a lower quality stream to the receiver 120. As additional network resources become available in the network 130, the last hop network element 136 may provide a higher quality flow to the receiver 120.

In a specific example, the last hop network element 136 may receive a request for a video stream from the receiver 120 identifying a stream S1G10. The last hop network element 136 subscribes to three different resolution flows (e.g., S1G1 at 4K, S1G2 at 1080p, and S1G3 at 720p) of the video stream. The source 110 provides each of these flows to the last hop network element 136. The last hop network element 136 selects one of the flows to provide to the receiver 120 to fulfill the request for the media stream.

In another example, the last hop network element 136 may create a NAT mapping for the NAT service 170 which translates the destination address of the selected quality flow to be the network address of the receiver 120. This enables the last hop network element 136 to quickly switch between flows of different quality by changing the NAT mapping. If the network performance of the flow currently being provided to the receiver 120 degrades, the last hop network element 136 may detect the degradation with the flow monitoring logic 160 and change the NAT mapping to route a flow of a different quality to the receiver 120.

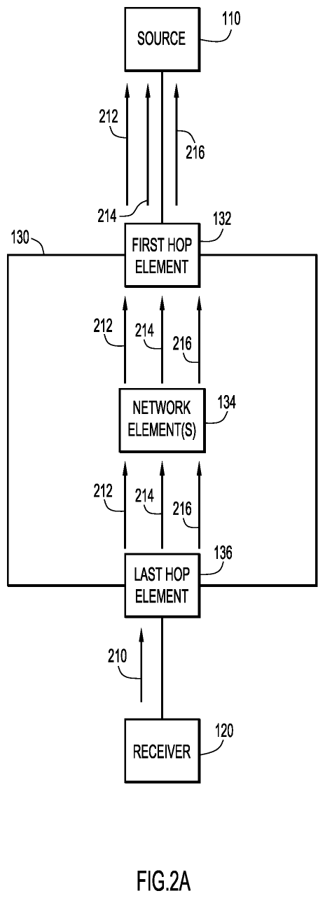

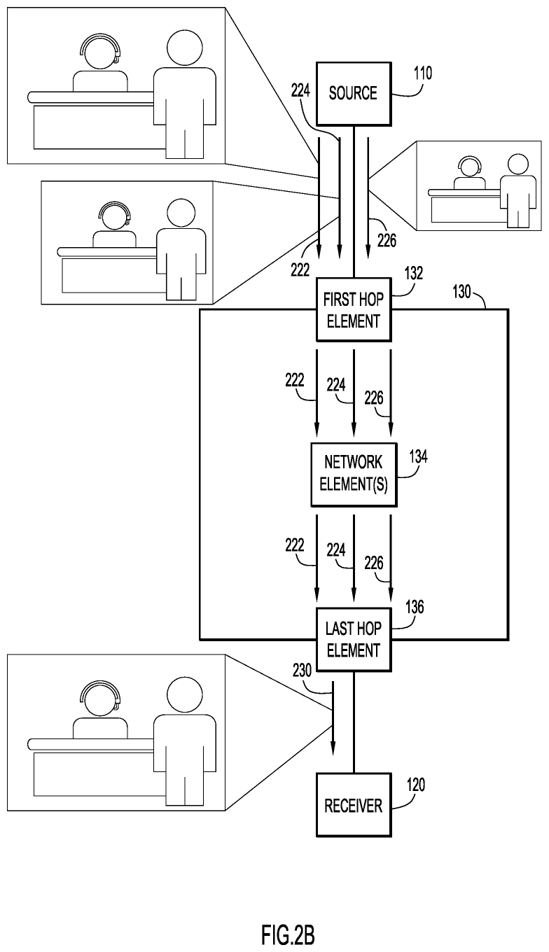

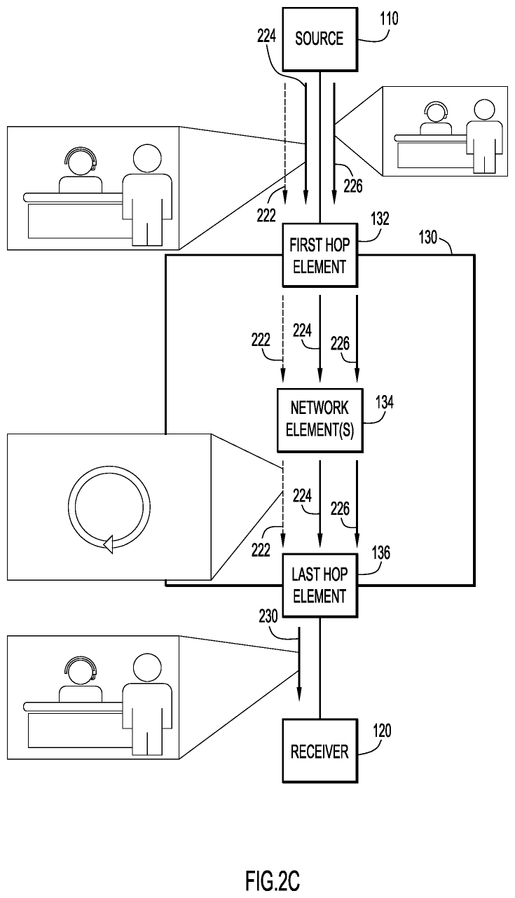

Referring now to FIG. 2A, an example of a receiver 120 requesting a media stream from a source 110 is shown. The receiver 120 sends a request 210 for a media stream to the source 110. In one example, the request 210 may identify a multicast source/group pair (e.g., S1G10) for the media stream. The last hop network element 136 intercepts the request 210 and determines that the source 110 is capable is providing the media stream at different levels of quality. The last hop network element 136 sends subscription messages 212, 214, and 216 subscribing to three different quality flows of the same media stream. The subscription messages 212, 214, and 216 may each identify a source/group pair associated with high quality, medium quality, and low quality flows, such as S1G1, S2G2, and S1G3, respectively. In one example, the last hop network element 136 may logically bundle the three quality flows (e.g., S1G1, S1G2, and S1G3) with the stream identified by the receiver 120 (e.g., S1G10). The logical association between the three quality flows and the stream identified by the receiver may be shared with some or all of the network elements in the network 130.

In another example, the request 210 and the subscription request messages 212, 214, and 216 may be Internet Group Management Protocol (IGMP) multicast join messages identifying the respective source/group pairs. On receiving the request 210 (e.g., an IGMP multicast join message identifying S1G10) from the receiver 120, the last hop network element 136 may consult a mapping table associating the stream identified in the request 210 and the flows of different quality levels. The last hop network element 136 may join the IGMP groups for all of the flows of different quality levels by sending subscription messages 212, 214, and 216 (e.g., IGMP join messages for S1G1, S1G2, and S1G3).

Referring now to FIG. 2B, and example of the last hop network element 136 providing a flow in response to the request 210 (e.g., an IGMP join for S1G10) for the media stream is shown. In this example, the source 110 provides three flows 222, 224, and 226 of the media stream that was requested by the receiver 120 in the request 210, as shown in FIG. 2A. The flow 222 is a highest quality (e.g., 4K resolution) flow, and may be associated with a source/group pair (e.g., S1G1). The flow 224 is a medium quality (e.g., 1080p resolution) flow, and may be associated with a source/group pair (e.g., S1G2). The flow 226 is a low quality (e.g., 720p resolution) flow, and may be associated with a source/group pair (e.g., S1G3). The flows 222, 224, and 226 are received by the first hop network element 132 and are passed through the internal network element(s) 134 to the last hop network element 136. The three flows 222, 224, and 226 may be logically bundled together in the network 130, such that each network element can determine that the flows 222, 224, and 226 are varying quality flows of the same media stream. The last hop network element 136 selects the high quality flow 222 to fulfill the request 210 of the receiver 120 with the flow 230.

In one example, the last hop network element 136 configures an egress NAT mapping to send the flow 222 (e.g., corresponding to S1G1) to the receiver as the requested flow 230 (e.g., corresponding to S1G10). The egress NAT mapping enables the last hop network element 136 to adjust the quality of the stream separately for multiple receivers, which may be connected to the last hop network element 136.

Referring now to FIG. 2C, an example of the last hop network element 136 changing flows in response to a degradation in network performance is shown. In this example, the high quality flow 222 experiences network performance issues, which the last hop network element 136 detects. In one example, the last hop network element 136 may detect the network performance issues as dropped packets in a Real-time-Transport Protocol (RTP) flow, as latency in the flow 222, or as excessive buffering required for the flow 222. The last hop network element 136 switches to providing the medium quality flow 224 as the flow 230 provided to the receiver 120 to ensure that the receiver obtains a continuous version of the media stream.

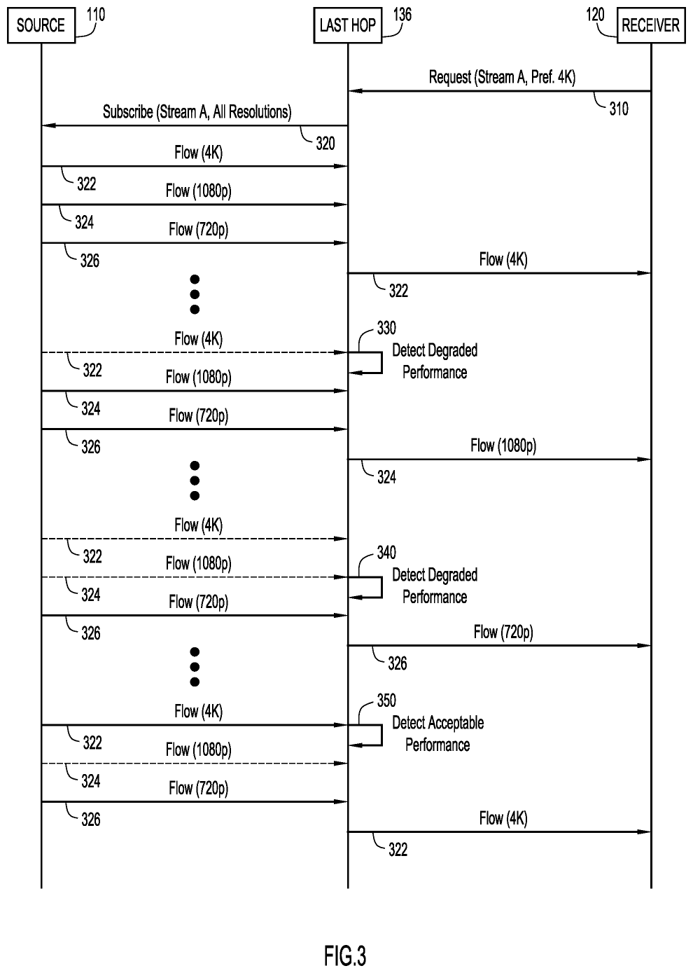

Referring now to FIG. 3, a message flow diagram illustrates messages passed between the source 110, the last hop network element 136 and the receiver 120 in providing the receiver with a media stream by seamlessly adjusting the flow quality. The receiver 120 sends a request 310 to the last hop network element 136. The request 310 identifies the media stream, and may include a preferred level of quality (e.g., 4K resolution) for the stream. In one example, the preferred level of quality may be indicated in a predefined IGMP packet extension. The last hop network element 136 receives the request 310, and sends a subscription message 320 to the source 110. The subscription message 320 identifies the stream and subscribes to flows of the stream at different levels of quality (e.g., different resolutions). In one example, the subscription message 320 may include multiple messages, with each message subscribing to a flow at a different level of quality/resolution.

In response to the subscription message 320, the source 110 provides three flows 322, 324, and 326 at different levels of quality to the last hop network element 136. The high quality flow 322 is a version of the media stream in 4K resolution. The medium quality flow 324 is a version of the media stream in 1080p resolution. The low quality flow 326 is a version of the media stream in 720p resolution. The last hop network element 136 receives the three flows 322, 324, and 326, and determines that the preferred level of quality (e.g., high quality flow 322 at 4K resolution) is available to send to the receiver 120. As long as the network performance of the high quality flow 322 is acceptable, the last hop network element 136 forwards the high quality flow 322 to the receiver 120. In one example, the last hop network element 136 may generate a NAT mapping to forward the high quality flow 322 to the receiver 120.

The last hop network element 136 monitors the network performance of all of the flows 322, 324, and 326, and detects that the network performance of the high quality flow 322 is degraded at 330. In one example, the last hop network element 136 may detect a number of packet drops that exceeds a predetermined threshold to determine that the network performance of the high quality flow 322 is degraded. In response to the degraded network performance of the high quality flow 322, the last hop network element 136 begins to send the medium quality flow 324 to the receiver 120. In this example, the last hop network element 136 selects the level of quality that is closest to the preference of the receiver 120.

While delivering the medium quality flow 324 to the receiver 120, the last hop network element 136 detects that the network performance of the medium quality flow 324 is degraded at 340. In response to the degraded network performance of the medium quality flow 324 and the high quality flow 322, the last hop network element 136 selects the low quality flow 326 to provide to the receiver 120.

At 350, the last hop network element 136 detects that the network performance of the high quality flow 324 has improved. In response to the improved network performance of the high quality flow 322, the last hop network element 136 forwards the high quality flow 322 to the receiver 120. In one example, the last hop network element 136 may detect the improved network performance by detecting a number of dropped packets in the high quality flow 322 that is below a predetermined threshold. The predetermined threshold for detecting degraded network performance may be different than the predetermined threshold for detecting improved network performance.

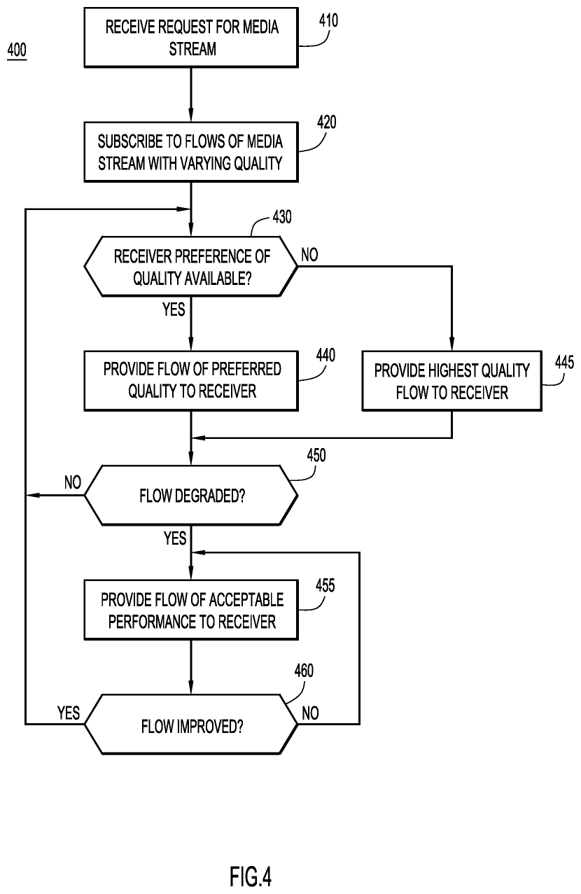

Referring now to FIG. 4, a flowchart illustrates operations performed by a network element (e.g., last hop network element 136) in a process 400 for monitoring and providing flows of a media stream to a receiver endpoint (e.g., receiver 120). At 410, the network element receives a request for a media stream. In one example, the request identifies the media stream with a source/group pair. In another example, the request includes a preferred level of quality for the stream. At 420, the network element subscribes to a plurality of flows of the media stream. The plurality of flows include versions of the media stream at different levels of quality. In one example, the network element correlates the media stream identified in the request with a logical grouping of the plurality of flows.

At 430, the network element determines whether the receiver has a quality level preference of the media stream, and if a flow with the quality level preference is available from the source of the media stream. The quality level preference may be defined in the request for the media stream or previously stored as a setting associated with the receiver. In one example, the quality preference may be defined by a specific level of quality (e.g., 4K resolution at 120 Hz frame rate). Alternatively, the quality preference may be defined as a range (e.g., at least 1080p resolution) or a combination of ranges (e.g., if the refresh rate is at least 120 Hz, then a resolution of at least 1080p). If the receiver has indicated a quality level preference, as determined at 430, and the source has provided a flow with that quality level, then the network element provides the flow of the preferred level of quality to the receiver at 440. If the receiver has not indicated a quality level preference, or if the flow at the quality level preference is not available, then the network element provides the highest quality flow of the media stream available at 445.

The network element monitors the flows of the media stream, and if the flow being provided to the receiver degrades, as determined at 450, then the network element provides a flow of acceptable performance to the receiver at 455. In one example, the network element may detect that the flow being provided to the receiver has dropped a significant number of packets (e.g., via gaps in the RTP sequence numbers of the packets in the flow) to detect that the performance is degraded. In another example, the network element may determine which flow has an acceptable performance level by monitoring the network performance of the plurality of flows of the media stream.

The network element continues to monitor the network performance of the plurality of flows, and if the performance of one of the flows that was degraded improves, as determined at 460, then the network element may return to providing a higher quality flow or the flow of the preferred quality level. In one example, the improvement in performance of the higher quality flow may be detected as a period of stability in which the network element does not observe any dropped packets in a predetermined time frame (e.g., 10 seconds), which may be user defined.

If the network performance of the flows remains the same, or degrades further, then the network element continues to provide a flow of acceptable performance to the receiver at 455. In one example, the network element may continue to lower the quality of flow provided to the receiver in order to provide a flow with acceptable performance. If none of the flows are able to provide acceptable performance, the network element may continue to provide the lowest quality flow to the receiver.

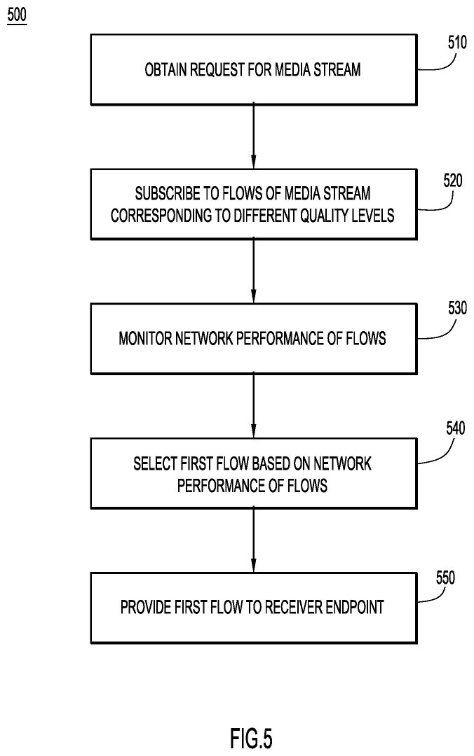

Referring now to FIG. 5, a flowchart illustrates operations performed by a network element (e.g., last hop network element 136) in a process 500 for providing a flow of a media stream to a receiver endpoint (e.g., receiver 120). At 510, the network element obtains a request for a media stream from a receiver endpoint. In one example, the request may indicate a source/group pair identifying a multicast flow of the media stream. At 520, the network element subscribes to a plurality of flows corresponding to different quality levels of the media stream. In one example, the network element may logically group the plurality of flows of different quality levels with the multicast flow requested by the receiver endpoint.

At 530, the network element monitors the performance of the plurality of flows. In one example, the network element may monitor a packet sequence number (e.g., an RTP sequence number), a latency, and/or an amount of egress buffering of each of the plurality of flows. At 540, the network element selects a first flow based on the network performance of the flows. In one example, the network element selects the highest quality flow that meets a predetermined threshold of network performance. In another example, the network element may select a lower quality flow based on the available bandwidth of the network. As network resources free up in the network, a higher quality flow may be selected. At 550, the network element provides the first flow to the receiver endpoint. In one example, the network element adjusts a NAT mapping to send the first flow to the receiver endpoint as the requested multicast flow of the media stream.

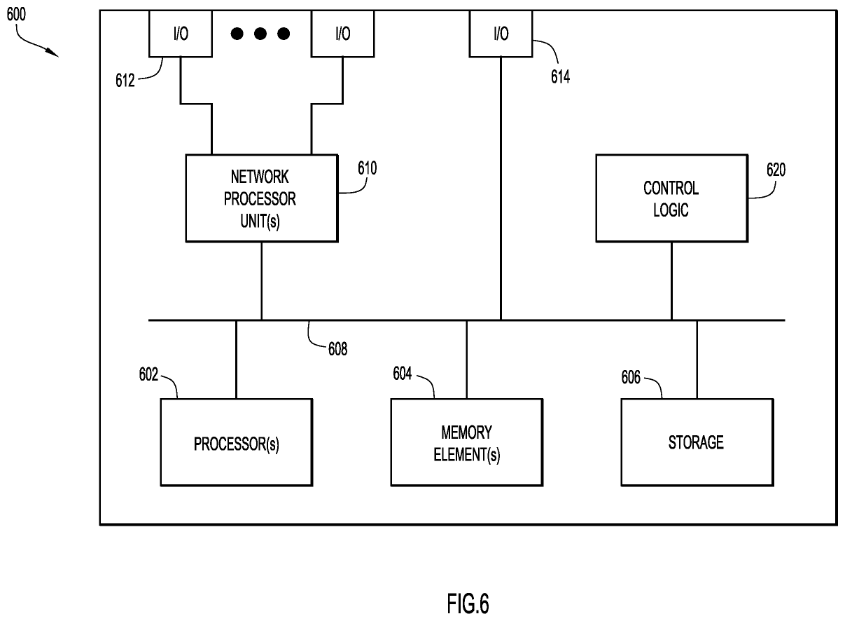

Referring to FIG. 6, FIG. 6 illustrates a hardware block diagram of a computing device 600 that may perform functions associated with operations discussed herein in connection with the techniques depicted in FIGS. 1, 2A, 2B, 2C, and 3-5. In various embodiments, a computing device, such as computing device 600 or any combination of computing devices 600, may be configured as any entity/entities as discussed for the techniques depicted in connection with FIGS. 1, 2A, 2B, 2C, and 3-5 in order to perform operations of the various techniques discussed herein.

In at least one embodiment, the computing device 600 may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, and/or any other I/O port(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computer device 600. For example, I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, entities for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In summary, by using fundamental analytics in the network, the network fabric makes streaming quality control seamless for endpoint devices, which reduces overall cost of operation and complexity for the end user. The techniques described herein provide for flexibly changing streams based on defined service level agreement (SLA) constraints.

In one form, a method is provided to provide a flow to a receiver endpoint. The method includes obtaining from a receiver endpoint a request for a media stream. The method also includes subscribing to a plurality of flows of the media stream. Each flow of the plurality of flows corresponds to a quality level of the media stream. The method further includes monitoring a network performance of each of the plurality of flows. The method also includes selecting a first flow among the plurality of flows based on the network performance of each of the plurality of flows, and providing the first flow to the receiver endpoint.

In another form, an apparatus comprising a network interface and a processor is provided. The network interface is configured to communicate with a plurality of computing devices. The processor is coupled to the network interface, and configured to obtain via the network interface from a receiver endpoint, a request for a media stream. The processor is also configured to subscribe to a plurality of flows of the media stream. Each flow corresponds to a quality level of the media stream. The processor is further configured to monitor a network performance of each of the plurality of flows. The processor is also configured to select a first flow among the plurality of flows based on the network performance of each of the plurality of flows, and cause the network interface to provide the first flow to the receiver endpoint.

In still another form, a non-transitory computer readable storage media is provided that is encoded with instructions that, when executed by a processor of a network device, cause the processor to obtain from a receiver endpoint, a request for a media stream. The instructions also cause the processor to subscribe to a plurality of flow of the media stream. Each flow corresponds to a quality level of the media stream. The instructions further cause the processor to monitor a network performance of each of the plurality of flows. The instructions also cause the processor to select a first flow among the plurality of flows based on the network performance of each of the plurality of flows, and provide the first flow to the receiver endpoint.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A method comprising:
obtaining from a receiver endpoint, a request for a media stream;
subscribing to a plurality of flows of the media stream, each flow corresponding to a quality level of the media stream;
monitoring a network performance of each of the plurality of flows;
selecting a first flow among the plurality of flows based on the network performance of each of the plurality of flows;
providing the first flow to the receiver endpoint by creating a Network Address Translation (NAT) mapping that associates a destination of the first flow with a network address of the receiver endpoint
detecting that the network performance of the first flow is degraded below a predetermined threshold;
selecting a second flow among the plurality of flows based on the network performance of the second flow; and
providing the second flow to the receiver endpoint by adjusting the NAT mapping to associate a destination of the second flow with the network address of the receiver endpoint.

2. The method of claim 1, wherein the quality level of the media stream is based on resolution or frame rate of a video stream.

3. The method of claim 1, wherein monitoring the network performance comprises monitoring one or more of a packet drop rate, latency, or egress buffering associated with each of the plurality of flows.

4. (canceled)

5. (canceled)

6. The method of claim 1, wherein the first flow corresponds to a first quality level of the media stream that is higher than a second quality level of the media stream corresponding to the second flow.

7. The method of claim 1, further comprising:
detecting that the network performance of the second flow is degraded below the predetermined threshold;
selecting a third flow among the plurality of flows; and
providing the third flow to the receiver endpoint.

8. The method of claim 1, further comprising:
detecting that the network performance of the first flow has improved above the predetermined threshold; and
providing the first flow to the receiver endpoint.

9. An apparatus comprising:
a network interface configured to communicate with a plurality of computing devices; and
a processor coupled to the network interface, the processor configured to:
obtain via the network interface from a receiver endpoint, a request for a media stream;
subscribe to a plurality of flows of the media stream, each flow corresponding to a quality level of the media stream;
monitor a network performance of each of the plurality of flows;
select a first flow among the plurality of flows based on the network performance of each of the plurality of flows;
create a Network Address Translation (NAT) mapping that associates a destination of the first flow with a network address of the receiver endpoint to cause the network interface to provide the first flow to the receiver endpoint;
detect that the network performance of the first flow is degraded below a predetermined threshold;
select a second flow among the plurality of flows based on the network performance of the second flow; and
cause the network interface to provide the second flow to the receiver endpoint by adjusting the NAT mapping to associate a destination of the second flow with the network address of the receiver endpoint.

10. The apparatus of claim 9, wherein the processor is configured to monitor the network performance by monitoring one or more of a packet drop rate, a latency, or an egress buffering associated with each of the plurality of flows.

11. (canceled)

12. (canceled)

13. The apparatus of claim 11, claim 9 wherein the processor is further configured to:
detect that the network performance of the second flow is degraded below the predetermined threshold;
select a third flow among the plurality of flows; and
cause the network interface to provide the third flow to the receiver endpoint.

14. The apparatus of claim 9, wherein the processor is further configured to:
detect that the network performance of the first flow has improved above the predetermined threshold; and
cause the network interface to provide the first flow to the receiver endpoint.

15. One or more non-transitory computer readable storage media encoded with software comprising computer executable instructions and, when the software is executed on a processor of a network device, operable to cause a processor to:
obtain from a receiver endpoint, a request for a media stream;
subscribe to a plurality of flows of the media stream, each flow corresponding to a quality level of the media stream;
monitor a network performance of each of the plurality of flows;
select a first flow among the plurality of flows based on the network performance of each of the plurality of flows;
provide the first flow to the receiver endpoint by creating a Network Address Translation (NAT) mapping that associates a destination of the first flow with a network address of the receiver endpoint
detect that the network performance of the first flow is degraded below a predetermined threshold;
select a second flow among the plurality of flows based on the network performance of the second flow; and
provide the second flow to the receiver endpoint by adjusting the NAT mapping to associate a destination of the second flow with the network address of the receiver endpoint.

16. The one or more non-transitory computer readable storage media of claim 15, wherein the software is further operable to cause the processor to monitor the network performance by monitoring one or more of a packet drop rate, latency, or egress buffering associated with each of the plurality of flows.

17. (canceled)

18. (canceled)

19. The one or more non-transitory computer readable storage media of claim 15, wherein the software is further operable to cause the processor to:
detect that the network performance of the second flow is degraded below the predetermined threshold;
select a third flow among the plurality of flows; and
provide the third flow to the receiver endpoint.

20. The one or more non-transitory computer readable storage media claim 15, wherein the software is further operable to cause the processor to:
detect that the network performance of the first flow has improved above the predetermined threshold; and
provide the first flow to the receiver endpoint.

21. The method of claim 1, wherein the request obtained from the receiver endpoint identifies a preferred quality level of the media stream.

22. The method of claim 1, wherein obtaining the request for the media stream comprises:
intercepting the request from the receiver endpoint to a source of the media stream; and
determining that the source of the media stream is capable of providing the plurality of flows of the media stream at different quality levels.

23. The apparatus of claim 9, wherein the request obtained from the receiver endpoint identifies a preferred quality level of the media stream.

24. The apparatus of claim 9, wherein the processor is configured to obtain the request for the media stream by:
intercepting the request from the receiver endpoint to a source of the media stream; and
determining that the source of the media stream is capable of providing the plurality of flows of the media stream at different quality levels.

25. The one or more non-transitory computer readable storage media of claim 15, wherein the request obtained from the receiver endpoint identifies a preferred quality level of the media stream.

26. The one or more non-transitory computer readable storage media of claim 15, wherein the software is further operable to cause the processor to obtain the request for the media stream by:
intercepting the request from the receiver endpoint to a source of the media stream; and
determining that the source of the media stream is capable of providing the plurality of flows of the media stream at different quality levels.
